(19) United States
(12) Patent Application Publication
(10) Pub. No.: US 2007/0211681 A1
(43) Pub. Date: Sep. 13, 2007

(54) Method and System for Frequency Agility in a Wireless Sensor Network

(75) Inventors: Xiangzhong Sun, Westford, MA (US); David L. Nelson, Framingham, MA (US)

Correspondence Address: BROMBERG & SUNSTEIN LLP, 125 SUMMER STREET, BOSTON, MA, 02110-1618, US

(73) Assignee: SPINWAVE SYSTEMS, INC., Westford, MA (US)

(21) Appl. No.: 11/683,593

(22) Filed: Mar. 8, 2007

Related U.S. Application Data
(60) Provisional application No. 60/780,664, filed on Mar. 9, 2006.

(51) Int. Cl. H04Q 7/24

(52) U.S. Cl. 370/338

(57) ABSTRACT

A method for providing frequency agility in a wireless network with a plurality of RF frequency channels. The nodes are formed into a hierarchical branching tree for communication. The RF environment for each of the plurality of RF channels is sensed as a function of time and the sensed measurements are stored. Based on the stored measurements of RF environment, a channel assignment scheme as a function of time is selected and transmitted to the network nodes. Nodes within the tree can be segmented geographically and assigned channels based on the sensed local RF environment. Nodes can also be segmented to reduce the density of nodes using the same assigned channels. Such frequency agility enhances the communication capability of a wireless sensor network in a harsh RF environment.

This application claims priority from U.S. provisional patent application No. 60/780,664, filed Mar. 9, 2006, entitled “Method and System for Frequency Agility in a Wireless Sensor Network,” attorney docket number 3079/101, which is incorporated herein by reference.

### TECHNICAL FIELD

The present invention relates generally to wireless sensor networks, and more particularly to techniques for reducing interference including frequency agility.

### BACKGROUND

Wireless sensor networks (“WSN”) have gained increasing acceptance in sensing and control applications. Over the past few years, WSNs have been applied in industries, such as building automation, industrial control, medical, and security. Various WSN technologies have been developed to serve this field. The IEEE 802.15.4 standard (“802.15.4”) has been widely disseminated and adopted. 802.15.4 addresses the physical layer and media access control (“MAC”) layers of WSN. (The IEEE 802.15.4-2003 standard was approved in May 2003 and will be referred to below.) Further, the Zigbee Alliance is an organization whose mission is advancement of monitoring and control applications using wireless networking. The Zigbee specification (“Zigbee”) addresses the network layer of WSNs. (The Zigbee specification is currently at version 1.1—and will be referred to below.) Radio frequency (“RF”) integrated circuits implementing WSN have become available from a number of vendors.

802.15.4 was developed for use in the industrial, scientific, and medical (“ISM”) frequency bands due to the unlicensed nature of these bands and the available bandwidth. These bands are occupied by devices that implement wireless specifications other than 802.15.4, so coexistence with these devices is an important consideration. Among the ISM bands, the 2.4 GHz spectrum is the most widely used due to its world wide availability. However, the 2.4 GHz spectrum is also being utilized by many different types of devices such as WiFi (IEEE 802.11), Bluetooth, etc. Also, because of the low RF power allowed with this technology, interference from various RF sources has been one of the leading factors causing unreliable operations of WSNs.

Reliability is considered one of the top adoption inhibitors in most WSN applications such as industrial control and monitoring, commercial building controls, security, etc. Attempts have been made to improve reliability using various means. Some common techniques include Frequency Hopping Spread Spectrum (“FHSS”) and Direct Sequence Spread Spectrum (“DSSS”) based channel-hopping mechanisms. The advantage of FHSS is that one can boost the RF transmission power significantly. (FCC 15.247 allows FHSS systems to reach a power level of up to 1 Watt.) However, FHSS is not applicable in most cases to the battery powered devices needed for sensors. Others have tried to utilize the available DSSS channels and hop uniformly through the channels with a pre-determined sequence to reduce interference. This method enhances the robustness of the network to spontaneous interference from random sources. However, in an environment that is known to have non-random interferences in segments of the RF spectrum, e.g., an office space with deployed WiFi networks, this mechanism may yield deteriorated performance in channels that overlap with interfering sources.

### SUMMARY OF THE INVENTION

In embodiments of the present invention, a method is provided for communicating among a plurality of nodes forming a hierarchical branching tree. The RF transmission characteristics of each of a plurality of channels are determined and stored in a channel profile. From the plurality of available channels, a “working set” (WS) is chosen by each individual node, representing the subset of channels which provide the greatest communications reliability. Nodes communicate their working set to their parent/children nodes. A method is provided to ensure that the WS of each node has sufficient channel overlap with the working set of each connected node to guarantee that each connected node pair in the network has at least one channel in common between its members. The choice of working set for each node is made on the basis of the channel quality measurements subject to the requirement that there be sufficient channel overlap between each child and parent. Each of the WS channels is employed in a timed sequence to transmit and receive messages. In a specific embodiment of the invention, a parent node transmits the timed sequence of channels to a child node to control message transmissions and receptions at the child node. In some embodiments, the WS selected may be based on results stored in the channel profile according to the time of day and/or day of the week.

In other embodiments of the present invention, a child node periodically sends a channel profiling message to a parent node over a given channel. The parent node updates the transmission characteristics for the given RF channel from the channel profiling message, when received. In some embodiments, the channel profiling message may include link quality statistics for the given channel and the parent node will incorporate these statistics into the channel profile.

In another embodiment of the present invention, a method is provided for communicating among a plurality of nodes that cover a relatively large geographic area in which the RF channel profile varies from one location to another. Portions of the WSN, called segments, follow different channel-hopping sequences tailored to the local RF environment. The channel-hopping sequences are selected using the stored channel profile. A minimum overlap of selected channels is maintained among directly connected nodes to ensure reliable communication.

In further embodiments of the present invention, a method is provided for communicating among a plurality of nodes using density frequency agility. Density frequency agility is performed to avoid forming high density wireless networks using the same channels and, thereby, causing communication degradation among the nodes due to self-interference. Density frequency agility is achieved by segmenting one network into multiple lower density networks, which use different RF channels within the same geographic space. When a node to be added attempts to connect to the network, the added node determines the number of children each potential parent node has. If the number is greater than a threshold number, the added node forms a new segment within the tree. The density of nodes within the tree using the same RF channels is thereby reduced, enhancing communication.

### BRIEF DESCRIPTION OF THE DRAWINGS

The foregoing features of the invention will be more readily understood by reference to the following detailed description, taken with reference to the accompanying drawings, in which:

FIG. 1A is a diagram of a tree topology of network nodes, according to an embodiment of the invention;

FIG. 1B is a block diagram of a network node, according to an embodiment of the invention;

FIG. 2 is a flow chart for a method for providing temporal frequency agility, according to an embodiment of the invention;

FIG. 3 is a flow chart for forming a hierarchical branching tree, according to an embodiment of the invention;

FIGS. 4A and 4B are flow diagrams for a method for joining tree segments into a single hierarchical branching tree without circular links, according to an embodiment of the invention;

FIG. 4C is a flow diagram for a method of reconnecting links in the hierarchical tree, according to an embodiment of the invention;

FIG. 5 is a flow diagram for sequencing RF channels for transmitting messages across the PAN, according to an embodiment of the invention;

FIG. 6 illustrates spatial frequency agility in an embodiment of the invention;

FIG. 7 is a flow diagram for a method for providing density frequency agility, according to an embodiment of the invention; and

FIG. 8 is a flow diagram for a method for adaptive message routing, according to an embodiment of the invention.

### DETAILED DESCRIPTION OF SPECIFIC EMBODIMENTS

In various embodiments of the present invention, a WSN is formed by connecting a plurality of nodes into a hierarchical branching tree. The nodes communicate over a set of shared wireless channels, selected from a plurality of channels. One or more of temporal, spatial and/or density frequency agility techniques are employed at selected times and locations within the WSN to reduce the interference with RF sources in the area, aiding reliable communication among the nodes.

Temporal frequency agility is achieved by performing channel-hopping based on an estimate of the performance of a plurality of RF communication channels. A channel profile is dynamically maintained based on measurements of the communication capability of each channel. This channel profile may be maintained according to the time of the day and/or calendar date, depending on the characteristics of the environment where the network operates. A channel-hopping sequence is created that takes advantage of the channels with the least interference. This sequence is disseminated to nodes within the WSN. Nodes in at least a portion of the WSN communicate with each other according to this channel sequence, enhancing communication reliability. Spatial frequency agility is provided by coordinating the nodes that cover a relatively large geographic area in which the RF channel profile varies from one location to another. Portions of the WSN, called segments, follow different channel-hopping profiles tailored to the local RF environment. Density frequency agility is performed to avoid forming high density wireless networks and, thereby, causing communication degradation among the nodes due to “self-interference.” Density frequency agility is achieved by separating one network into multiple lower density networks which run in different RF channels within the same geographic space. The network tree is segmented to reduce the density, leading to improved communication. These techniques may be combined in a WSN to enhance communication reliability and performance.

Temporal Frequency Agility

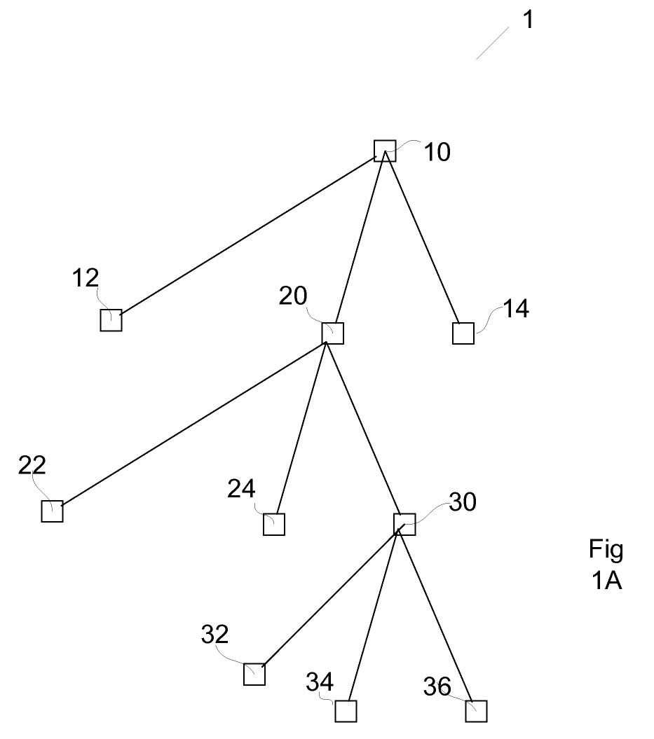

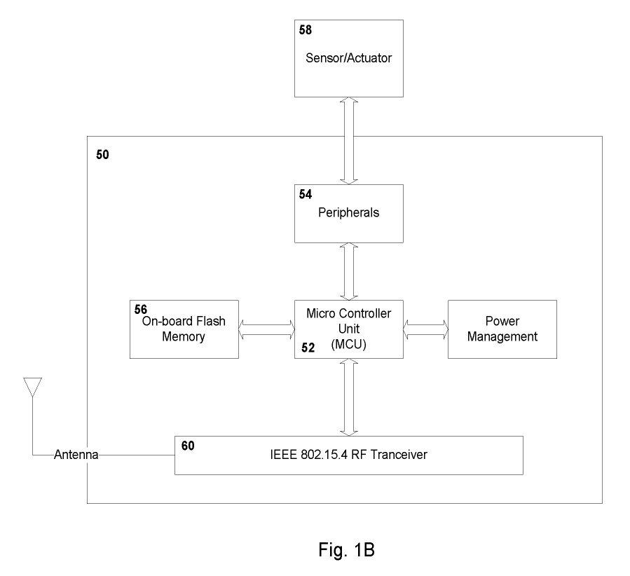

In an embodiment of the invention, as shown in FIG. 1A, a WSN, also known as a personal area network (“PAN”), is formed as a hierarchical branching tree 1 (i.e., a tree with clusters). A PAN coordinator node 10 is at the top of the hierarchy and is the primary controller of the PAN. Other nodes 12, 20, 30 within the PAN may be full-function devices (“FFDs”) or reduced-function devices (“RFDs”). FFDs include routing capability and are allowed to have FFDs and RFDs 14, 22, 24, 32, 34, 36 as child devices.

The PAN operates with a synchronous global time base. This synchronous time base allows RFDs to run in a battery conserved mode with their RF receiver turned off a majority of the time. Synchronization of the global time is achieved by transmitting specific messages across the network. The specific messages may also carry RF channel-hopping information. The PAN coordinator 10 is responsible for starting the network and for choosing key network parameters. PAN coordinator functions and the procedure for starting the network may be as described in the 802.15.4 and the Zigbee specifications.

An FFD 50 may be implemented according to the block diagram shown in FIG. 1B, in some embodiments of the invention. A microcontroller 52 executes algorithms and store results in its internal random access memory. The FFD may be connected to a sensor or actuator 58 via peripheral circuits 54. These sensor/actuators may be a temperature sensor, fire or smoke detector, carbon monoxide detector, relays, etc. The microcontroller can input readings from the sensor and can provide control signals to determine the mode of operation of the sensor 58. The peripheral interfaces 54 may include analog-to-digital converters, general purpose digital I/O, and serial communication interfaces (UART, SPI, T²C, RS-232, RS-485, etc.). (Some FFDs may be used without attached sensors.) The microcontroller 52 is connected to an 802. 15.4 RF transceiver 60 through a serial interface such as UART, SPI, or 1²C. The microcontroller can control the transceiver 60 and can transmit and receive data through the transceiver. For example, the microcontroller 52 can select the RF channel on which the transceiver 60 transmits/receives. In some embodiments, the microcontroller can read the energy transmitted in an RF channel, as measured by the transceiver 60. The on-board flash memory 56 is an optional functional block which can store tables, databases, and algorithms that are needed by the microcontroller. In a specific embodiment of the invention, the PAN coordinator 10 chooses the initial RF channel and PAN identifier according to the following illustrative procedure:
1. The PAN coordinator performs an energy scan to determine the energy in each RF channel. An EnergyDetectList, with the energy in each channel, is populated in MLME-SCAN.confirm as the result of the energy scan.
2. The PAN coordinator performs a passive scan to determine PAN Ids in use within range. A PAN DescriptorList is populated in MLME-SCAN.confirm.
3. Choice of channel:
   a. Among channels with measured energy less than a threshold parameter aEnergyDetectMax, choose an empty channel (i.e., there is no PAN ID on that channel) with the least measured energy. If multiple channels meet the criteria, choose the channel with highest channel number.
   b. If there is no empty channel with measured energy less than aEnergyDetectMax, choose the “best” channel according to the following precedence:
      i. least number of PAN Ids on the channel;
      ii. lowest measured energy for the channel; and
      iii. highest channel number.
   c. If there is no channel with measured energy less than aEnergyDetectMax, choose the one channel with the smallest number.
4. Choice of PAN ID
   a. Uniformly randomly choose a PAN ID in set S₁={unsigned integer i: 0<i<65535}and {PAN ID not in PANDescriptorList}.
   b. If S₁=Ø, choose a PAN ID in set S2 ={unsigned integer i: 0<i<65535} and {PAN ID not in PANDescriptorList within the same channel}.
   c. If S₂=Ø, go to step 3 to find the next best channel.
5. If neither channel nor PAN ID is available, signal a failure of “unable to start a PAN.” (This should never happen under practical situations, however.)

By way of example, RF environmental profiling can consist of physical layer profiling and MAC layer profiling. For physical layer profiling, an energy scan is performed for the current channel periodically, and the physical channel score is updated as

S_{phy}(i)=Eᵢ,

where i is the index of the current channel, and Eᵢ is the energy value detected by the energy scan operation. For example, the RF transceiver may be able to measure the energy transmitted in each RF channel and make these measurements available to a microcontroller in an FFD or an RFD. For MAC layer profiling, the initial value of the channel score S_{mac}(i) is set to zero. At each retry, when an ACK is requested for a packet transmitted by the node, the corresponding S_{mac} (i) is incremented by one—the second retry increments S_{mac}(i) by two, the nth retry increments S_{mac} (i) by n, etc. Also, on successful transmissions for which no retries are needed, S_{mac} (i) is decremented by the number of successful transmissions without retries divided by an adjustable constant. Depending on the particular implementation, there is a maximum value S_{MAX} for S_{mac} (i). If S_{mac} (i) reaches its maximum value, the scores are resealed according to the following:

S_{phy}(i)=α(S_{phy}(i)),

where α is a function of the original channel score such that the resulting value S_{phy}(i) is smaller than its original value. The same profiling algorithm may run on all FFD nodes. A parent FFD can optionally send out a MAC command frame to one or more of its child nodes to get profile data from the child node. This procedure is by way of illustration only and other profiling algorithms may be used in various embodiments of the invention.

The channel-hopping sequence can be created from the combination of the channel scores from both physical layer profiling and MAC layer profiling. The reliability of a channel is derived from the channel profile as follows,

R(i)=S_{MAX}−C_{phy}S_{phy}(i)−C_{mac}S_{mac}(i),

where C_{phy} and Cₘₐₓ are implementation dependent constants governing the importance of physical layer profiling versus the MAC layer profiling. By setting C_{phy} or Cₘₐₓ to zero, the consideration of the physical layer profiling or the MAC layer profiling is removed, respectively. This is necessary, for example, when the radio chip cannot perform reasonably precise energy measurement during the energy scan, in which case, the physical layer profiling should be discounted by setting C_{phy} to a smaller value or even zero. The value of R(i) is updated whenever the respective channel score is updated.

The “usefulness” of a channel is defined by the following quantity:

A(i)=max{0, (R(i)−R_{MIN})},

where R_{MIN} is a threshold for a channel that is usable.

By way of example, selection of the sequence of RF operating channels may be performed according to any one of the following three options:
1. Always choosing the channel that has the maximum A(i);
2. Uniformly hopping through the channels with the value A(i) greater than 0; or
3. Hopping through the channels with the value A(i) greater than 0, and the duration of staying in the channel is a function of A(i) so that channels with higher value of A(i) have longer operating time.

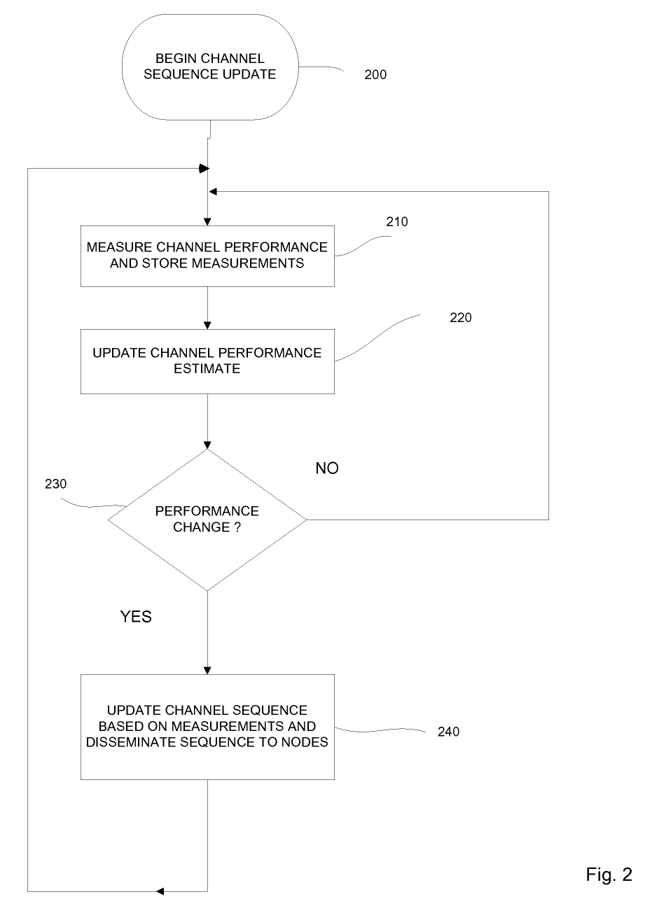

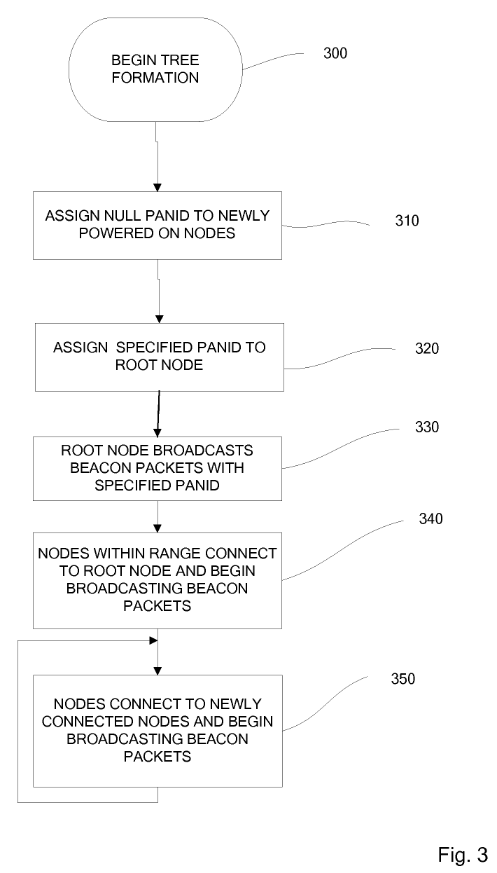

A flow diagram for a method of providing temporal frequency agility 200 in a WSN, according to an embodiment of the invention is shown in FIG. 2. The term “temporal” means here that the RF channel “hops” or changes as a function of time. Measurements of channel performance are taken and stored 210. Channel performance estimates are then updated 220. If channel performance estimates have not changed 230, channel performance measurements 210 are repeated. When channel performance estimates have changed, an updated channel-hopping sequence is created and disseminated 240 to nodes for communication. Channel measurements 210 are then repeated.

In specific embodiments of the invention, the PAN coordinator node 10 stores RF channel profiling data as a function of the time at which the profiling is performed. Based on these stored values of profiling data, the PAN coordinator node can adjust the sequence of RF operating channels according to time of day or the date or both. Thus, temporal frequency agility is provided, allowing the reliability of the network to be enhanced.

Self Organizing Topology

In embodiments of the invention, a method is provided for forming a singly connected hierarchical branching tree. Each node within the tree must have only one parent node and no parent node can be connected to any of its descendent nodes, i.e., the tree cannot contain circularities. When nodes power up or are reset, each node is provided a token. Two nodes cannot connect unless each node has a token. When a parent-child connection is formed, one of the nodes in the pair gives up its token. Thus, a tree is constructed containing a single token.

When a node outside the tree wishes to connect to a node in the tree, the node in the tree broadcasts a token request message through the tree. The node in the tree with the token sends the token to the requesting node. The requesting node and the node outside the tree then each have a token and the nodes connect, extinguishing one token. Thus, the tree retains only a single token. In this way, a node cannot connect to one of its descendent nodes in the tree because only one of the nodes will have a token at a given time.

A node within the tree can reconfigure its connection from its parent node to a second node within the tree. When the node initiates the reconfiguration by attempting to connect to the second node, the second node broadcasts a token request message through the tree. The node in the tree with the token then sends the token to the second node. The reconfiguring node then disconnects from its parent and generates a token. Since the reconfiguring node and the second node (the reconfiguring node's parent to be) each have a token, the connection proceeds, with one token extinguished when the connection is completed.

In an embodiment of the invention, a set of nodes that are within communication range of each other form a single hierarchical branching tree for a PAN, guaranteeing that (1) the tree is singly connected, i.e., each node has only one parent node and (2) the tree does not have any circular paths, i.e., a node connected as a child to one of its descendent nodes (child nodes, grandchild nodes, etc.). When a node is first powered on, the node is assigned a null PanID 300, 310 which will prevent the node from broadcasting beacons. A newly powered-on node will wait until the node detects another node in its vicinity which has been given a legitimate PanID. A collection of recently powered-on nodes will forever listen for a beacon from a potential parent. Eventually, through an installation procedure, one of the nodes will be assigned a globally unique PanID 320. This node becomes the “root node” for the network. A root node never seeks a parent node for itself The beacon packet emanating from a root node will have a bit set to indicate that the node is a root node. PanID conflicts will occur only among beacons where this bit is set, thereby permitting multiple cluster head nodes to transmit beacon packets with the same PanID, as long as only one of these nodes is a root node.

Nodes within range of the root node will initiate a connection to the root node 340, inheriting the root's PanID. These newly connected nodes then broadcast their own beacon packets in response to beacon requests from potential children. Nodes that are out of range of the root node, but within range of the newly connected nodes will then connect 350 to one of the newly connected nodes. Members of this latter group of nodes become parents of others nodes 350, forming a hierarchical branching tree.

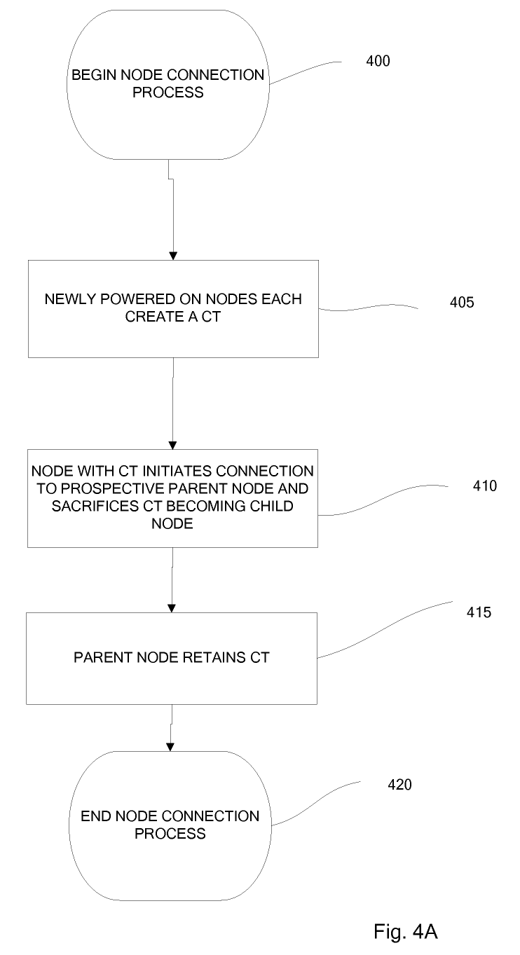

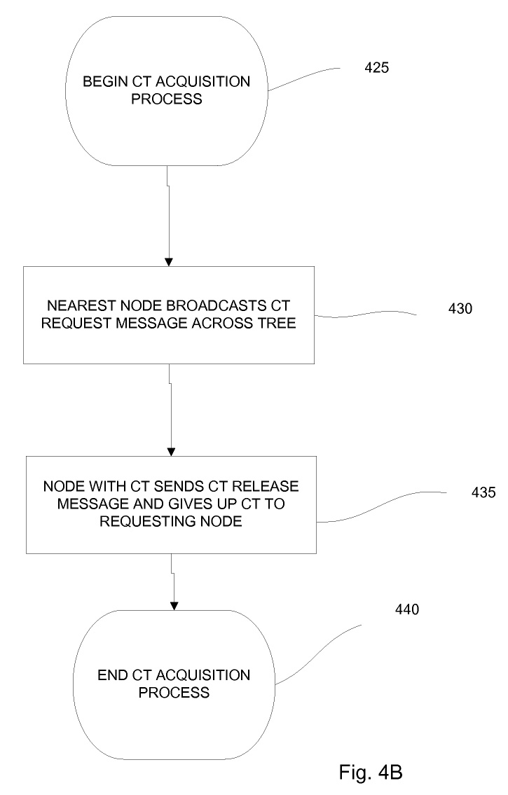

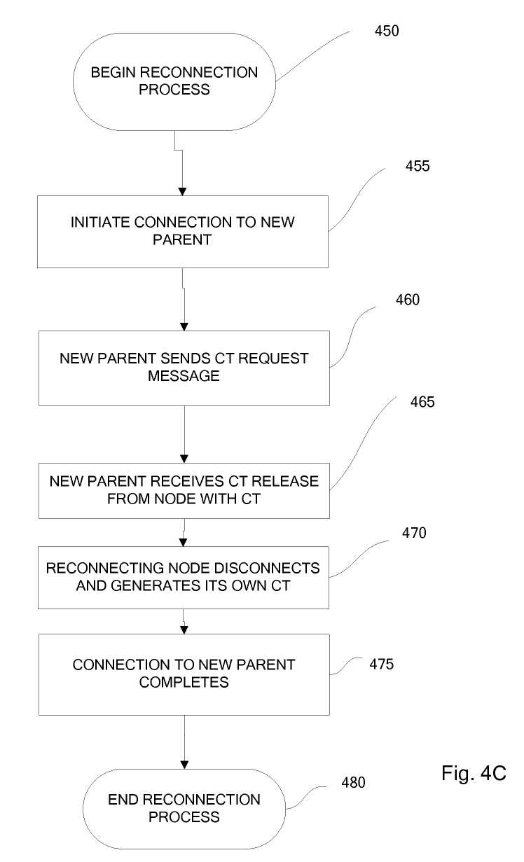

If at some point a link in the tree is broken, two networks with the same PanID will then exist. However, there will still be a single root node in the two networks—the original node which was first assigned the PanID. The “head” of the disconnected segment will seek a parent that has the same PanID. An algorithm 400 will be executed, as shown in FIG. 4A, which permits a separated “head node” to rejoin the network, but prevents the head node from erroneously reconnecting to another node within the disconnected segment, forming a circularity. To accomplish this task, the algorithm employs a Connection Token (“CT”). When a node is first powered on, the node is endowed with a CT 405. In order for two nodes to interconnect, both nodes must first possess a CT. The initiator of the connection sacrifices its CT 410 upon completion of the connection, becoming a child node. The parent node's CT survives 415 the connection process. The connection process then completes 420. Clearly, as the tree grows, a single CT will exist among the nodes in the tree.

If a new node is powered on in the vicinity of an existing tree, or otherwise seeks to connect to the tree, but the nearest node in the tree does not possess the CT, the nearest node begins a CT acquisition process 425. This nearest node broadcasts a CT Request message 430 across the tree. The node in the tree that currently possesses the CT will relinquish ownership by sending back a CT Release message 435 directly to the requesting node. The CT acquisition process then completes 440. The new connection can then proceed as above (405, 410, 415, 420) with the new child node relinquishing its CT when the connection is made. Thus, the CT moves around the tree in the direction of the tree's growth.

Once connected, all nodes in the tree attempt new connections when nodes not connected to the tree are detected. The node in the tree will acquire the CT and attempt to connect to the newly discovered node. Note that if this connection was attempted between nodes of the same tree, it will be impossible for both sides to simultaneously possess the single CT contained in the tree. This mechanism prevents circularities within the same tree. Note further that if the potential connection is between two independent trees, the trees will successfully join into one common tree.

Further, all nodes periodically reevaluate their connections by analyzing relative signal strengths of nodes within communication reach. A node may then choose to reorganize its connection to the tree by disconnecting and reconnecting with another node in the tree. The frequency at which each node performs this reevaluation is very low to avoid wasting bandwidth and power. For example, the nodes may “reevaluate their connections” every 90 minutes in some embodiments or at some other similar preset interval. The reevaluation frequency may also be set adaptively.

When a node willingly disconnects, the node generates a CT in a fashion similar to the case of the node being powered off and on again. FIG. 4C illustrates the process of reevaluating a connection, disconnecting and forming a connection to another node 450. Before the node disconnects, however, the node should attempt to connect to the new parent in order to force the new parent to acquire the CT, particularly if the disconnecting node currently possesses the CT. In this case, the reorganizing node will (1) attempt to connect to a better parent, 455 (2) receive a CT Request (from the potentially new parent) 460, (3) issue a CT Release, 465 (4) disconnect from its current parent, generating its own CT 470, and (5) proceed with the new connection 475, as described above, completing the process 480.

In general, nodes will not be permitted to reconnect to another parent having a different PanID unless explicitly enabled to do so. Enabling nodes to resign from a tree with one PanID and join a tree with another PanID would be permitted only if there is some back-door routing mechanism that would join the two networks, as would be the case, for example, if they were both connected with a gateway to a common Ethernet backbone.

It is possible that the CT of a tree will become lost, particularly if the current owner becomes orphaned or powered off To recover lost CTs, the network root node periodically creates its own CT and simultaneously issues a CT Request across the tree to flush out any current owners.

After creating a new CT, root nodes should be inhibited from participating in new connections unless it is clear the root node possesses a unique CT, for example, by receiving a CT Release. If the root node has not received a CT Release, a pathological case could arise where there are temporarily two CTs in the same tree. This is a harmless temporary condition as long as the root node does not participate in connections. Should this condition arise, then after a substantial number of CT Requests, the root node can assume any extra CTs have perished. The root node can then proceed as if its own CT was unique. Note that the situation where the root node does not receive a CT Release will arise if the current CT owner becomes orphaned. But this orphan node will acquire and sacrifice a new CT when it eventually reconnects and so no extra CTs will be introduced. The only case where multiple CTs could simultaneously exist is if the root's CT Request was lost. This situation is why the root node avoids connections until a substantial number of such CT Requests have been repeated. In a specific embodiment of the invention, the root node will retransmit the CT Request fifteen times if no CT Release message is received. The root node will then act as if the CT is unique and will be free to enter into new connections.

Background Channel Profiling Process

In determining the channel quality profile, a background channel assessment process may be employed, in some embodiments of the invention. In this process, each node in the network sends a series of “roam” message to its parent, according to a pre-determined schedule. Roam messages in the series are sent in turn on each RF channel in the set of available RF channels. The roam message, if received, is processed by the parent node. Reception of the roam message contributes information to the estimate of RF quality of the RF channel for that message. The contribution to the estimate of channel quality of each roam message may be either link quality of the RF channel, as indicated in the message, or simply the fact that the message was received by the parent on the RF channel. The link quality in the message for the channel may be derived from a hardware measurement or from collected MAC layer statistics.

The frequency at which a node sends the series of roam messages may be determined adaptively. At network startup, this process is performed more often so that the system can achieve a meaningful channel profile quickly. In time, the channel profile will converge to a steady state distribution based on environmental RF characteristics. At that point, frequent execution of the roaming message transmission process may not provide information causing significant changes in the channel profile. Instead, the roaming message transmission process will consume network bandwidth and battery power. To optimize network performance and conserve battery power, the pace of performing the roaming processes can be slowed down accordingly.

Nodes may send the series of roam messages more frequently if the nodes experiences difficulties in communicating, such as frequent retries, many lost packets, etc. When this happens, nodes will send the series of roam messages more frequently so that the network can “learn” about changes in the RF environment sooner.

The frequency of roam message transmission at startup may be determined by adaptation parameters at each node. Adaptive control of roam message transmission frequency may be performed based on parameters sent by a controller node or may be determined at each node based on the channel profile and other statistics maintained at the node.

Channel Spinning/Channel Multiplexing

In an embodiment of the invention, temporal frequency agility, as described above, can be effected using a set of active RF channels employed in sequence during a time period instead of a single active RF channel used throughout the time period. Only one RF channel is used at an instant in time, however. This channel sequencing or “spinning” enables nodes to operate over multiple communication channels in turn, resulting in strong interference mitigation capability against spontaneous interferences. A node can then use more than one active RF channel to communicate with its parent and its children. Channel spinning enables the network to survive the loss of communication over several channels without causing major disruption to the operation of the network.

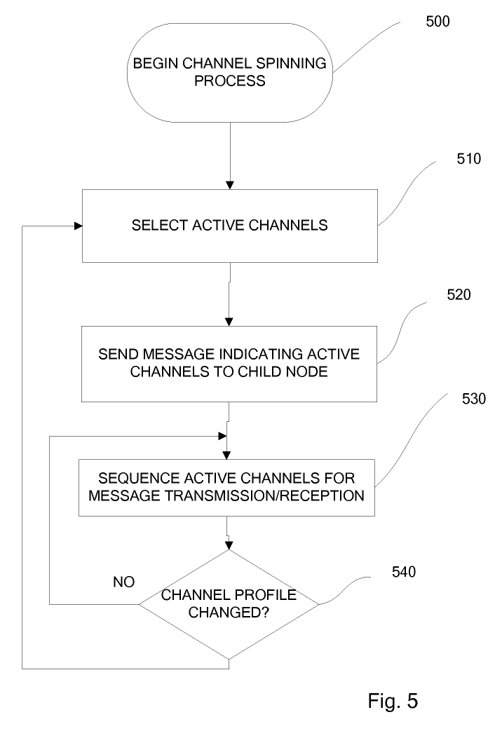

To accomplish channel spinning, each node sequences the RF channel the node uses for transmission and reception among up to a specified number of active RF channels. The channel in use at any instant of time changes in sync with a globally synchronized clock. FIG. 5 is a flow diagram for the channel spinning process 500. Selection of the active RF channels from the available set of RF channels is determined by selecting those RF channels 510 with the highest levels of channel quality, as measured by the channel profiling process. When the node has selected the set of active channels, the channel selection and sequencing 520 is sent to each of the node's child nodes. The node then sequences 530 its active RF channel according to this sequence. As the quality of the channels changes over time due to environmental factors, the choice of the set active of RF channels at each node can also change 540. Of course, to maintain the integrity of the network, each node must guarantee an overlap of its active channels with those of its neighbors (parent, children), but over a large geographic area, the operating channels will migrate to those of highest local quality, referred to as spatial agility. Because the nodes are synchronized according to the globally synchronized clock and each node knows the sequence of active RF channels of the nodes with which it communicates (parent, children), each node can determine the active RF channel at any instant and time its transmissions and reception to effect message transmission/reception.

In a specific embodiment of the invention, the number of active channels for a node at any time is four, selected from sixteen available RF channels. The operative set of four channels are chosen so that at least two of the four RF channels will overlap with the node's parent and child node's active channels at any given time.

Spatial Frequency Agility

In another embodiment of the invention, spatial frequency agility is used whereby the temporal agility described above is employed independently at every node (hence every location, or across the entire network space) subject to the constraint that pairs of connected nodes have sufficient channel overlap (one or more channels in common with each other) so as to guarantee communication with each other.

Spatial frequency agility permits the wireless network to span geographies where certain frequency RF channels are unavailable at certain locations (e.g., due to interference.) These channel ‘dark spots’ restrict the selection of operating channels only for the network connections that operate in the specific location. With spatial frequency agility, a network can span a geography wherein potentially each channel is inoperative at some location in the area, as long as all channels are not inoperative at the same location.

In order to maintain time synchronization, sleeping RFD sensor nodes will occasionally awake and listen for a beacon transmission from its parent. In order to maximize battery life, the time of listening for the RFD should be minimized. To do this, the timing of the next beacon message must be anticipated. In some embodiments of the invention, time slots are divided into intervals called micro-time slots. To avoid deterministic interference, the start times of messages are randomly distributed across a plurality of micro-time slots, (64 for example.) With beacon transmissions randomly scheduled over micro-time slots, the RFD would normally have to listen on average half a time slot before the beacon is sent. In specific embodiments of the invention, this idle listening is avoided by providing RFDs with the internal state of the random number generator used by its parent so that the RFD can efficiently compute the expected beacon transmission to the resolution of a micro-time slot. For example, if the parent node provides the RFD with the seed of the pseudo-random number generator algorithm and state information on where the parent is in the random number sequence, the RFD can predict the micro-time slot in which the parent will next transmit by computing the next pseudo-random number in the sequence.

In another embodiment of the invention, an alternative method of maintaining time synchronization is provided. RFDs wake up at prescheduled times and then query their parent nodes for synchronization information. The synchronization information may include a global synchronized time, the current working set of operating channels, the anticipated changes in the working set of channels, and other implementation specific properties for the operation of the network.

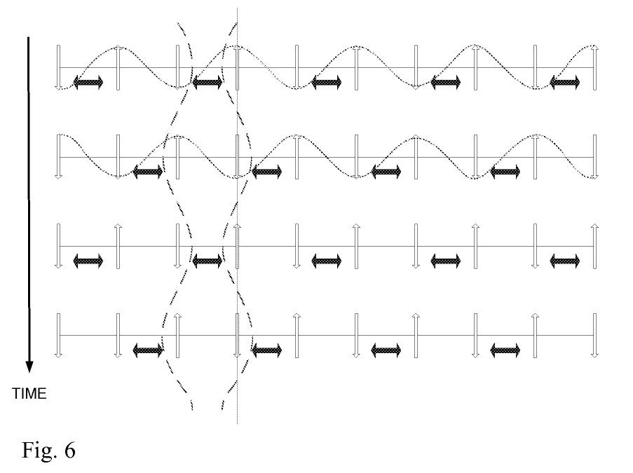

FIG. 6 illustrates the concept of a virtual carrier for message transmission, analogous to a “spin wave” in physics, which addresses spatial agility, assuming two channels in the current working set of the active channels. The vertical axis represents advancing time in the downward direction. Network nodes are represented by vertical hollow arrows. While the node point “upwards”, it communicates on the channel operated in the segment to its left; and vice versa. The horizontal bi-directional arrows indicate the cleared communication paths when adjacent nodes are able to communication with each other on the same RF channels. Each horizontal “time slice” represents a subsequent time slot. The nodes operate on two different channels in subsequent time slots to serve two regions (segments). Each node flips between upstream (spin up) and downstream (spin down). Packets propagate across the network through the nodes. Thus, a spin wave, which is represented by the horizontal sinusoids, forms a virtual carrier to enable data communication across the network.

Density Frequency Agility

In other embodiments of the invention, density frequency agility is used to avoid forming a PAN where the density is so high that communication degrades among the nodes due to “self-interference.” Density frequency agility is achieved by segmenting one network into multiple lower density clusters, called density agility segments, which run in different RF channels within the same geographic space. These segments within the PAN are joined together by nodes operating on different working sets of active RF channels between the node's upstream link and the node's downstream link. We call these nodes “covalent nodes” (“CN”). These covalent nodes route messages between the density agility segments. Each density agility segment consists of the CN and its connected descendents (e.g, children, grandchildren, etc.) that share the same WS as the CN node. Thus, a second CN that is a descendent of a first CN is a member of its own density agility segment, not the density agility segment for which the first CN is the head node. The reduced number of nodes running on a single RF channel (or a WS of channels) due to this segmentation improves communication reliability by reducing the likelihood of collisions. Any FFD in the network is qualified to be a CN and the role of CN can be determined adaptively.

In an embodiment of the invention, a node seeking to join the PAN interrogates nearby CNs to determine how many child nodes each CN has in its density agility segment. The node to be added then connects to the CN with the least number of attached child nodes in its density agility segment. If the number of nodes on a CN reaches a specified maximum value, then the CN will refuse to attach any further regular (non-covalent) child nodes to itself In the case that no nearby CN node has available capacity to attach further noncovalent child nodes to its density agility segment, the node to be added will become a covalent node, forming its own density agility segment, thereby further segmenting the network. (The added node attaches to a CN as a covalent child node.) With the new density agility segment, the PAN can continue to add nodes without increasing the density of existing density agility segments beyond the specified maximum number of regular child nodes.

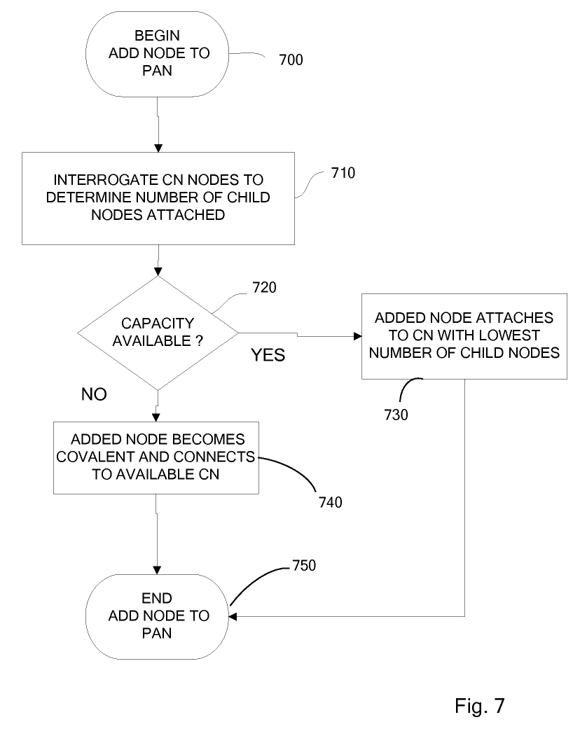

FIG. 7 is a flow diagram for a method 700 for providing density frequency agility in a WSN, according to an embodiment of the invention. When a node seeks to join the PAN, the added node interrogates 710 available CNs within communication range to determine how many child nodes are attached to each CN's density agility segment. If the number of nodes in the density agility segment on at least one of the CNs is less than a specified maximum number of nodes 720, the added node attaches as a regular child node 730 to the CN with the lowest number of attached child nodes in its segment. If all of the available CNs have the maximum specified number of child nodes attached to their segments, the added node attaches to one of the CN nodes and becomes covalent 740, forming a new density agility segment. In this way, capacity to add nodes is provided without increasing the density of existing segments in the PAN.

Of course, in various embodiments of the invention, temporal, frequency and spatial agility may be employed in any combination to provide increased reliability to the WSN.

Adaptive Routing

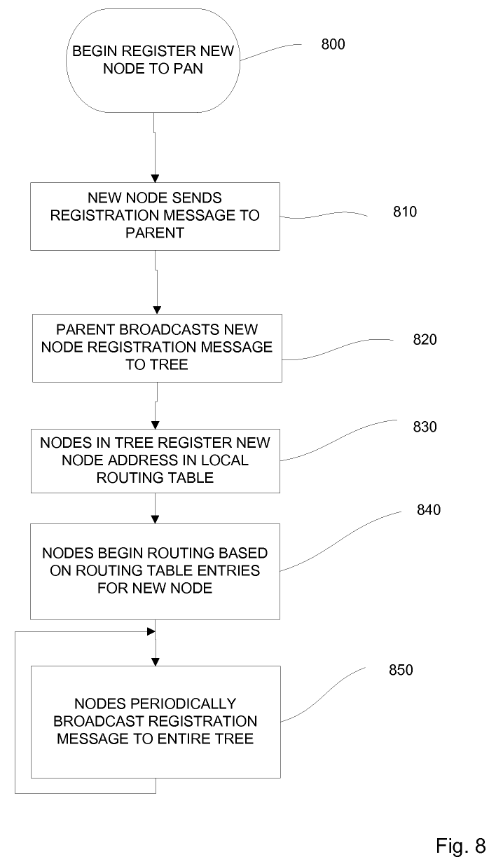

In embodiments of the invention where a singly connected hierarchical branching tree is guaranteed, such as by the technique described above, a publish/subscribe approach 800 to managing an adaptive routing table can be employed, as illustrated in FIG. 8. When a node is initially connected to the tree, and periodically thereafter, the node sends a registration message to its parent 810. The parent in turn broadcasts the registration message 820 to all other connections, flooding the entire tree with the message. As the registration message propagates throughout the network, each node registers the address of the new node 830 in its routing table along with the associated connection from whence the registration message came. This information is sufficient to allow the node to direct any subsequent messages intended for this new node to the proper connection 840.

To reduce the storage requirement of the routing table, two assumptions are imposed: first, any routing to the node's parent is assumed to be the default and need not be entered into the table, and second, all child nodes have their address listed as part of the connection itself and therefore requires no extra entry in the table. Consequently, the routing table is reduced to routing nodes that are grandchildren and all successive generations of grandchildren and grandparents and all successive generations of ancestors.

To maintain the integrity of the routing table at each node, each node periodically sends a broadcast registration message 850 across the tree with the node's address. Each node that receives the message may then update its routing table accordingly.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof In an embodiment of the present invention, predominantly all of the logic may be implemented as a set of computer program instructions that is converted into a computer executable form, stored as such in a computer readable medium, and executed by a microprocessor within the array under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, C#, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.) Embodiments of the invention include devices comprising a processor and memory, where the memory contains instructions that cause the processor to perform the steps of any of the above described embodiments of the invention. Further, embodiments of the invention include computer program products for use on a computer system where the computer program product comprises a computer usable medium having computer readable program code thereon, the computer readable program code including program code for performing the steps of any of the above described embodiments of the invention.

The present invention may be embodied in other specific forms without departing from the true scope of the invention. The described embodiments are to be considered in all respects only as illustrative and not restrictive. In particular, references to the 802.15.4 specification and the Zigbee specification are by way of illustration and embodiments of the invention may be implemented in various forms that do not conform to either of these specifications.

We claim:

1. A method for communicating among a plurality of nodes using at least one shared wireless channel selected from a plurality of wireless channels, the nodes forming a hierarchical tree, the method comprising:
a. profiling the transmission characteristics of each of the plurality of channels for a given period of time and storing the results;
b. selecting the shared channel based on the stored results;
c. transmitting the identity of the shared channel to the plurality of nodes; and
d. communicating between at least two nodes of the plurality of nodes using the shared channel.

2. A method according to claim 1, further including:
e. repeating step a; and
f. selecting the shared channel based on the stored results, wherein selecting the channel includes selecting based on stored results from a plurality of time periods.

3. A method according to claim 2, wherein selecting the shared channel includes selecting the channel for a time period that recurs periodically.

4. A method according to claim 3, wherein selecting the shared channel includes selecting the channel for a time of day.

5. A method according to claim 3, wherein selecting the shared channel includes selecting the channel for a day of the week.

6. A method according to claim 1, wherein profiling the transmission characteristics of the channel include at least one of physical layer profiling and MAC layer profiling.

7. A method according to claim 1, wherein profiling the transmission characteristics of each of the plurality of channels includes:
receiving a message at a parent node from a child node over a given channel from the plurality of channels, and
updating the stored transmission characteristics for the given channel using the message.

8. A method according to claim 7, wherein the message contains link quality information for the given channel.

9. A method according to claim 7, wherein the frequency of performing the step of receiving a message at a parent node is determined based on a link quality.

10. A method according to claim 1 wherein the at least one shared wireless channel includes a selected plurality of channels from the plurality of wireless channels and communicating between at least two nodes includes communicating over a given channel from the selected plurality of channels, the given channel determined from a sequence of the selected plurality of channels and the time of communicating.

11. A method according to claim 10 wherein a parent node from the plurality of nodes transmits the sequence of the selected plurality of channels to a child node of the parent node.

12. A method for forming a singly connected hierarchical branching tree from a plurality of nodes, comprising:
a. providing each node with a token;
b. making a connection between a first node and a second node from the plurality of nodes, the second node's token extinguished when the connection is made.

13. A method according to claim 12,
c. forming a connection from a third node from the plurality of nodes to the second node, the second node connected to the first node as a child node, the third node including a token, including:
broadcasting a token release message from the second node to the first node,
sending the token from the first node to the second node, and
making the connection between the second node and the third node, the second node connected as a parent node to the third node, wherein one of the tokens is extinguished when the connection is made.

14. A method according to claim 12 further comprising:
c. reconfiguring the connection between the third node and the second node, the reconfigured connection linking the third node to a fourth node as parent to child, the fourth node connected to the first node as child to parent, including:
initiating the connection from the third node to the fourth node,
broadcasting a token request message from the fourth node,
then transmitting a token release message from the second node to the fourth node, thereby moving the token to the fourth node,
then disconnecting the third node from the second node and generating an additional token at the third node, and
connecting the third node to the fourth node and extinguishing the additional token.

15. A method for communicating among a plurality of nodes using shared wireless channels selected from a plurality of wireless channels, the nodes forming a hierarchical tree including at least a first node connected to a second node, the first node related to the second node as parent to child, the first node also connected to a third node, the third node related to the first node as parent to child, the method comprising:
a. profiling the transmission characteristics of each of the plurality of channels for a given period of time and storing the results;
b. assigning a first wireless channel for communicating between the first node and the third node, based on stored channel transmission characteristics;
c. assigning a second wireless channel for communicating between the first node and the second node, based on the stored channel transmission characteristics, the second wireless channel differing from the first wireless channel; and
d. receiving a first message at the first node from the third node on the first wireless channel and forwarding the first message from the first node to the second node on the second wireless channel,
wherein the first node communicates over the first wireless channel and the second wireless channel in different time slots.

16. A method according to claim 15, wherein profiling the transmission characteristics includes the first node retrieving channel transmission characteristics from the second node.

17. A method according to claim 15, further including:
e. receiving a second message at the first node from the second node on the second wireless channel and forwarding the second message from the first node to the third node on the first wireless channel

18. A method according to claim 15, further including:
e. repeating steps a, b and c, periodically.

19. A method according to claim 15, wherein the time slots are fixed in length.

20. A method according to claim 19, wherein the time slots are divided into a plurality of micro-time slots of fixed length and transmissions are aligned with a micro-time slot.

21. A method according to claim 20, wherein the micro-time slots are randomly assigned to nodes for transmission.

22. A method for communicating among a plurality of nodes using shared wireless channels selected from a plurality of wireless channels, the nodes forming a hierarchical tree, the tree including a plurality of covalent nodes, each covalent node associated with a density agility segment of connected descendent nodes, the method comprising:
a. determining the number of descendent nodes associated with the density agility segment of each covalent node;
b. identifying a specified covalent node such that no other node among the plurality of nodes has more descendent nodes within the density agility segment of the specified covalent node;
c. when the number of descendent nodes within the density agility segment connected to the specified node is less than a threshold number of nodes, connecting an added node to the specified node as a noncovalent child node.

23. A method according to claim 22, further including:
d. when the number of descendent nodes within the density agility segment connected to the specified node is equal to the threshold number of nodes, connecting an added node to the specified node as a covalent child node, the specified node communicating with nodes within its density agility segment using a first set of channels and the added node communicating with nodes within its density agility segment using a second set of channels, where the first set of channels and the second set of channels differ in at least one channel.

24. A method according to claim 23, further including:
e. receiving a message on the second set of wireless channel at the added node and forwarding the message to the specified node on the first set of wireless channels.

25. A method for routing messages in a singly connected hierarchical branching tree among a plurality of wireless nodes, the plurality of nodes containing a parent node and at least one child node of the parent node, the method comprising:
a. transmitting a registration message from the child node to the parent node;
b. broadcasting the received registration message from the parent to the plurality of nodes;
c. updating a routing table at each node to include the address of the child node and the connection from which the registration message was received;

26. A method according to claim 25 wherein the registration message is transmitted from the child node to the parent node when the child node is first connected to the parent node.

27. A device for communicating over a wireless network of devices, the devices connected into a hierarchical tree, the devices communicating using at least one shared wireless channel selected from a plurality of wireless channels, the device including:
a. a sensor;
b. an RF transceiver c. a processor including memory, the memory including processor instructions for performing:
i. profiling the transmission characteristics of each of the plurality of channels for a given period of time and storing the results,
ii. selecting the shared channel based on the stored results,
iii. transmitting the identity of the shared channel to at least one node of the wireless network of devices, and
iv. communicating between at least two nodes of the plurality of nodes using the shared channel.

28. A device according to claim 27, the memory further including processor instructions for performing:
v. repeating profiling the transmission characteristics of each of the plurality of channels for a given period of time and storing the results; and
vi. selecting the shared channel based on the stored results, wherein selecting the channel includes selecting based on stored results from a plurality of time periods.

29. A method according to claim 28, wherein selecting the shared channel includes selecting the channel for a time period that recurs periodically.
